(19) United States
(12) Patent Application Publication
(10) Pub. No.: US 2019/0084332 A1
(43) Pub. Date: Mar. 21, 2019

(54) Unknown

(71) Applicant: Mitsubishi HiTec Paper Europe GmbH, Bielefeld (DE)

(72) Inventors: Nico Päuser, Leopoldshohe (DE); Nevelle Bower, Meerbusch (GB); Claudia Vogel, Bielefeld (DE); Monika Stubbe, Lembruch (DE)

(73) Assignee: Mitsubishi HiTec Paper Europe GmbH

(21) Appl. No.: 16/135,217

(22) Filed: Sep. 19, 2018

(30) Foreign Application Priority Data
Sep. 21, 2017 (DE) 102017121936.6
Sep. 18, 2018 (DE) 102018122212.2

(51) Int. Cl. B41M 5/52; B41M 5/50

(52) U.S. Cl. CPC B41M 5/5218; B41M 5/506

(57) ABSTRACT

An inkjet recording material having a metallic look, at least having a sheetlike substrate with a front side and a reverse side opposite the front side, a metal layer applied to the front side of the substrate by an adhesive, and an ink-absorptive layer applied atop the metal layer. The inkjet recording material having a metallic look is used as a label, photo, poster or packaging material, to a process for producing an inkjet recording material having a metallic look.

### BACKGROUND OF THE INVENTION

### 1. Field of the Invention

The present invention relates to an inkjet recording material having a metallic look, the use of an inkjet recording material having a metallic look, especially as label, photo, poster or packaging material, and to a process for producing an inkjet recording material having a metallic look.

### 2. Description of the Prior Art

Inkjet printers have been in very wide use for decades for printing of paper, films, materials etc., not just in the industrial and office sector but also in the domestic sector. They are notable for very good printing results, such that not only is the colored and black-and-white printing of texts and simple images possible, but also the color printing of photos and complex, fine patterns.

In inkjet printers, tiny droplets of ink are sprayed from a nozzle onto a medium to be printed, the ink droplets being produced, for example, by a piezoelectric element or with the aid of a heating element. Ink compositions used for inkjet printing may be aqueous inks, oil-based inks or solid inks (melt-type inks). However, aqueous inks are preferred and are used customarily since they have advantages in production, handling, and with regard to their odor and safety.

In order to obtain a very good printed image, factors of relevance in inkjet printers are not just the quality of the printer but also the quality of the medium to be printed. What is particularly important is that the incoming ink can be well absorbed by the medium without running in the surface of the sheet or penetrating too deep into the medium. This is of relevance especially in the printing of detailed graphics or photos where high resolution, i.e. many dots per inch (DPI), of the printed image should be achieved in order to obtain a good printed image.

### SUMMARY OF THE INVENTION

Moreover, the surface of the medium to be printed may have been specially finished, such that the image has a glossy or matte appearance, for example. For specialty applications, there is regularly a search for new papers printable with inkjet printers that have a novel surface effect.

One aspect of the invention is an inkjet recording material having a metallic look, at least comprising:

a sheetlike substrate (1) having a front side and a reverse side opposite the front side;
a metal layer (3); and
an ink-absorptive layer (4) applied atop the metal layer (3).

The inkjet recording material according to one aspect of invention makes it possible for the first time to provide a metallic look in an inkjet printing material. The inkjet recording sheets of the invention are especially suitable for label, photo or poster printing in which the metallic look of the inkjet recording material of the invention causes a particular effect.

The metal layer (3) may be applied to the front side of the substrate (1) by use of an adhesive (2) or be applied to the front side of the substrate (1) by vapor deposition of the metal.

If the metal layer has been applied to the front side of the substrate (1) by use of an adhesive (2), an adhesive (2) has been disposed between the sheetlike substrate (1) and the metal layer (3) and bonds the metal layer (3) to the sheetlike substrate (1). The adhesive (2) is preferably a polyurethane adhesive.

Preference is given to a configuration of the inkjet recording material wherein the sheetlike substrate (1) is a coated or uncoated paper. The paper used may be any conventional printing paper, base paper, packaging paper, label paper, kraft paper, or else specialty paper.

In a less preferred configuration of the inkjet recording material, the sheetlike substrate is a film. However, the use of a coated or uncoated paper is preferred in accordance with the invention.

Preference is given in accordance with the invention to an inkjet recording material in which the adhesive (2) is a polyurethane adhesive. In-house studies have shown that polyurethane adhesives have the best properties to bond the metal layer (3) to the sheetlike substrate. It is especially important here that the adhesive has good adhesive properties both on the sheetlike substrate and on the metal layer (3) and, even after storage, there is no reaction with the metal layer (3) or diffusion of the adhesive (2) or individual constituents of the adhesive layer (2) into other layers. Particularly when an aluminum layer is used as metal layer (3), particular preference is given to the use of a polyurethane adhesive.

The advantage in the case of use of an adhesive layer between the metal layer and the substrate is that this also allows use of substrates that do not have sufficient surface smoothness and/or do not have sufficient stability with respect to the conditions that exist in the vapor deposition of the metal. It is thus possible for the first time to use paper as sheetlike substrate, for example. The use of an adhesive layer here has the advantage that unevennesses in the substrate can be compensated for by the adhesive layer.

Vapor deposition of the metal has the advantage that it is possible to dispense with an additional adhesive layer. This makes it possible also to produce inkjet recording materials having a lower thickness.

In a preferred configuration of the inkjet recording sheet of the invention, the adhesive layer (2) has a thickness of 0.1 to 20 μm, preferably a thickness of 1 to 10 μm, most preferably of 2 to 5 μm. For example, about 3 g of adhesive is applied per square meter of substrate.

Preference is given to an inkjet recording material according to one aspect of the invention wherein the metal layer (3) is an aluminum layer, copper layer, gold layer, silver layer or a metal alloy layer; the metal layer (3) is preferably an aluminum layer. An example of a metal alloy that can be used in the metal alloy layer is bronze as copper-tin alloy (CuSn).

Preference is likewise given to an inkjet recording material according to one aspect of the invention, wherein the metal layer (3), which is preferably an aluminum layer, has a thickness of 1 to 100 nm, preferably a thickness of 10 to 75 nm, most preferably of 15 to 30 nm.

Preference is likewise given to an inkjet recording material according to one aspect of the invention wherein the metal layer (3), which is preferably an aluminum layer, has a coat weight of 0.05 to 0.15 g/m², preferably of 0.06 to 0.13 g/m², more preferably of 0.08 to 0.10 g/m².

Preference is further given in accordance with one aspect of the invention to an inkjet recording material wherein the ink-absorptive layer (4) comprises pigments and is a microporous or nanoporous ink absorption layer.

A “microporous ink absorption layer” in the context of the present invention is a coating, the composition of which comprises fine pigment particles and these have a pore diameter, measured with the aid of gas adsorption according to DIN 66135, of less than 1 μm and more than 0.3 μm.

A “nanoporous ink absorption layer” in the context of the present invention is a coating, the composition of which comprises fine pigment particles and these have a pore diameter, measured with the aid of gas adsorption according to DIN 66135, of less than 300 nm.

It is preferable in accordance with one aspect of the invention when the pigments have a pore diameter, measured with the aid of gas adsorption according to DIN 66135, of less than 1 μm, preferably less than 750 nm, more preferably less than 500 nm.

It is preferable in accordance with one aspect of the invention when the pigments have a pore diameter, measured with the aid of gas adsorption according to DIN 66135, of more than 15 nm, preferably more than 50 nm, more preferably more than 100 nm.

It is preferable in accordance with one aspect of the invention when the pigments have a pore diameter, measured with the aid of gas adsorption according to DIN 66135, in the range from 15 nm to 1000 nm, preferably 50 nm to 750 nm, more preferably 100 nm to 500 nm.

Preference is further given to an inkjet recording material according to one aspect of the invention wherein the ink-absorptive layer (4) has a dry weight in the range from 10 to 35 g/m², preferably in the range from 12 to 25 g/m², most preferably in the range from 15 to 25 g/m².

When the dry weight is less than 10 g/m², the resulting ink-absorptive layer (4) cannot completely absorb the inks for full-color printing. If the dry weight of the ink-absorptive layer (4) is more than 35 g/m², the resulting inkjet recording material can be too thick and the ink-absorptive layer (4) can have a tendency to form cracks during drying or during use.

Preference is likewise given to an inkjet recording material according to one aspect of the invention wherein the ink-absorptive layer (4) is transparent or has an opacity to ISO 2471 of not more than 80%, preferably not more than 50%, more preferably not more than 30%.

The opacity of the ink-absorptive layer (4) is determined to ISO 2471 by analysis of the isolated layer. For this purpose, for example, an ink-absorptive layer (4) having the same composition and thickness can be mounted on a fully transparent carrier (e.g. quartz glass) and analyzed.

Preference is likewise given to an inkjet recording material according to one aspect of the invention wherein the ink-absorptive layer (4) comprises silica, aluminum oxide and/or an aluminum oxide hydroxide. Preference is given here to an inkjet recording material of the invention wherein the ink-absorptive layer (4) comprises silica or boehmite (AlO(OH) or γ-AlOOH).

Preference is further given in accordance with one aspect of the invention to an inkjet recording material wherein the ink-absorptive layer (4) comprises boric acid or a borate.

Particular preference is given in accordance with one aspect of the invention to an inkjet recording material wherein the ink-absorptive layer (4) has a proportion by mass of 0.001 to 0.1, preferably 0.01 to 0.05, boric acid or borate, based on the polyvinyl alcohol used with preference as binder.

Ink-absorptive layers (4) to be used with preference in accordance with one aspect of the invention are described, for example, in DE 69402121 T2. The ink-absorptive layers (4) specified in examples 1 and 2 therein are particularly preferred in accordance with the invention.

Preference is further given to an inkjet recording material according to one aspect of the invention wherein the ink-absorptive layer (4) comprises a binder, preferably a binder selected from the group consisting of polyvinyl alcohol, copolymer of polyvinyl alcohol, ethylene-vinyl acetate copolymer, starch, styrene-butadiene latex, styrene-acrylate latex.

In-house studies have shown that inkjet recording sheets of the invention have particularly good properties when polyvinyl alcohol is used as binder.

Preference is given here to an inkjet recording material wherein the ink-absorptive layer (4) includes polyvinyl alcohol as a binder or as the binder, preferably a polyvinyl alcohol having a) a degree of hydrolysis of more than 50 mol %, preferably more than 75 mol %, more preferably more than 90 mol % and/or b) a degree of polymerization of at least 500, preferably of at least 800, more preferably of at least 1000.

In-house studies have likewise shown that inkjet recording sheets have particularly good properties when the polyvinyl alcohol used as binder has the properties specified here in detail.

The degree of polymerization can be determined with the aid of gel permeation chromatography (GPC), using tetrahydrofuran (THF) as solvent/eluent, polyvinyl alcohol as standard and an RI detector. The differential refractive index detector (RI=refractive index detector) measures the difference between the refractive index of the sample and the pure THF solvent.

Preference is further given in accordance with the invention to an inkjet recording material wherein the sheetlike substrate (1) is backed by an adhesive layer (5) on the reverse side. The adhesive layer backing (5) makes it possible for the user to use the inkjet recording material as a self-adhesive label. For example, it is possible to use the printed inkjet recording material for identification of products. The adhesive layer backings (5) may be covered by a separate release paper (6) until they are used. The term “separation paper” can also find use as a synonym for release paper. In a preferred configuration, the adhesive layer backing (5) is a polyacrylic resin adhesive or hotmelt adhesive.

In this case, the inkjet recording material can be used as a label or as a self-adhesive poster.

Preference is given in accordance with the invention to an inkjet recording material wherein a) no further layer is disposed between the metal layer (3) and the ink-absorptive layer (4) and/or b) no further layer is disposed atop the ink-absorptive layer (4) and/or c) no further layer is disposed between the adhesive (2) and the metal layer (3).

Preference is likewise given in accordance with the invention to an inkjet recording material wherein no further layer is disposed between the sheetlike substrate (1), which is preferably a coated or uncoated paper, and the adhesive layer (2).

According to one aspect of the invention, the metal layer (3) is applied to the front side of the substrate (1) by use of an adhesive (2). Correspondingly, an adhesive layer (2) is formed between the substrate (1) and the metal layer (3). Thus, an adhesive layer (2) has been applied to the front side of the substrate (1). The metal layer (3) is disposed atop the adhesive layer (2).

Preference is further given to an inkjet recording material of the invention wherein the metal layer (3) and/or the ink-absorptive layer (4) is disposed over the full area of the sheetlike substrate (1). Alternatively, it is possible that the metal layer (3) has been applied only to parts of the substrate (1) and the ink-absorptive layer (4) have been applied over the full area.

Particular preference is given in accordance with the invention to an inkjet recording material having a metallic look, at least comprising: a sheetlike substrate (1) having a front side and a reverse side opposite the front side, where the sheetlike substrate (1) is coated or uncoated paper, an aluminum layer (3) applied to the front side of the substrate (1) by use of a polyurethane adhesive (2), and an ink-absorptive layer (4) applied atop the aluminum layer (3).

Particular preference is given in accordance with the invention to an inkjet recording material wherein the sheetlike substrate (1) is a coated or uncoated paper, wherein the adhesive (2) is a polyurethane adhesive, wherein the metal layer (3) is an aluminum layer having a thickness of 15 to 30 μm, wherein the ink-absorptive layer (4) has a dry weight in the range from 10 to 35 g/m², wherein the binder in the ink-absorptive layer (4) is polyvinyl alcohol, wherein the polyvinyl alcohol has a degree of hydrolysis of more than 50 mol % and a degree of polymerization of at least 500, wherein the ink-absorptive layer (4) has a proportion by mass of 0.001 to 0.1 boric acid or borate, based on the polyvinyl alcohol used as binder, and wherein the ink-absorptive layer (4) is transparent or has an opacity to ISO 2471 of not more than 80%.

Particular preference is given in accordance with the invention to an inkjet recording material wherein the sheetlike substrate (1) is a coated or uncoated paper, wherein the metal layer (3) is an aluminum layer having a coat weight of 0.05 to 0.15 g/m², wherein the ink-absorptive layer (4) has a dry weight in the range from 10 to 35 g/m², wherein the binder in the ink-absorptive layer (4) is polyvinyl alcohol, wherein the polyvinyl alcohol has a degree of hydrolysis of more than 50 mol % and a degree of polymerization of at least 500, wherein the ink-absorptive layer (4) has a proportion by mass of 0.001 to 0.1 boric acid or borate, based on the polyvinyl alcohol used as binder, and wherein the ink-absorptive layer (4) is transparent or has an opacity to ISO 2471 of not more than 80%.

For later use, the inkjet recording material may be cut to size to suitable formats, for example sheets or rolls adapted to the particular use. According to the invention, sheets or rolls that have been cut to size are also regarded as inkjet recording materials.

A further aspect of the present invention relates to the use of an inkjet recording material of the invention for printing with an inkjet printer, preferably for printing of labels, photos, posters, books, photo books, displays, playing cards or collecting cards, entry tickets, ID cards, tags or packaging materials.

All the configurations and combinations of the invention that have been specified above for the inkjet recording material of the invention, including the configurations and combinations specified as preferred in each case, are also applicable to the use of the invention without restriction and if appropriate in an analogous manner.

A further aspect of the invention relates to a process for producing an inkjet recording material, preferably for producing an inkjet recording material of the invention, comprising:
producing or providing a multilayer composite composed of a metal layer (3), a release layer and a carrier layer;
producing or providing a sheetlike substrate (1), having a front side and a reverse side opposite the front side;
coating the front side of the sheetlike substrate (1) produced or provided and/or the metal layer (3) of the multilayer composite with an adhesive (2);
laminating the multilayer composite that has optionally been coated with the adhesive (2) onto the sheetlike substrate produced or provided that has optionally been coated with the adhesive (2), such that the adhesive (2) is disposed between the front side of the sheetlike substrate (1) and the metal layer (3);
partly or fully drying or curing the adhesive (2), so as to result in an adhesive layer (2);
removing the carrier layer and the release layer;
corona-treating the metal layer (3);
producing or providing a coating composition for production of the ink-absorptive layer (4);
applying the coating composition produced or provided to the metal layer (3); and
drying the coating composition applied, to form an ink-absorptive layer (4).

A further aspect of the present invention relates to an alternative process for producing an inkjet recording material, preferably for producing an inkjet recording material of the invention, comprising:

producing or providing a sheetlike substrate (1) having a front side and a reverse side opposite the front side;
coating the front side of the sheetlike substrate (1) produced or provided with a metal layer (3) by physical gas phase deposition;
producing or providing a coating composition for production of the ink-absorptive layer (4);
applying the coating composition produced or provided to the metal layer (3); and
drying the coating composition applied to form an ink-absorptive layer (4).

In the context of the present invention, physical gas phase deposition (physical vapor deposition, PVD for short) is understood to mean a process in which, with the aid of physical methods, a metal is converted to the gas phase and then guided to the substrate (1) to be coated, where the metal condenses and forms the metal layer (3).

Preference is given in accordance with the invention to a process wherein the sheetlike substrate (1) is a coated or uncoated paper.

Preference is likewise given to a process of the invention wherein the metal layer (3) is an aluminum layer, copper layer, gold layer or silver layer; the metal layer (3) here is preferably an aluminum layer.

Preference is likewise given to a method of the invention wherein the coating composition is applied by means of a curtain coater method, a roller transfer method or an intaglio printing method. Preference is given in accordance with the invention to the applying of the coating composition with the aid of an intaglio printing method. In the intaglio printing method, the coating composition is applied to a steel roll etched with a pattern. Subsequently, the sheetlike substrate (2) provided with a metal layer (3) that has been subjected to a corona treatment is pressed against this steel roll by a roller and the coating composition is transferred. Different speeds of the rollers result in rubbing of the coating composition, such that the pattern from the steel roll disappears and uniform application is the result.

Preference is likewise given to a process of the invention wherein, after the coating composition has been applied and before the coating composition has been dried, excess material is stripped off with a blade.

Preference is likewise given to a process of the invention wherein the carrier layer of the multilayer composite is a polyester carrier.

All the configurations and combinations of the invention that are specified above for the inkjet recording material of the invention, including the configurations and combinations specified as preferred in each case, are applicable to the process of the invention without restriction and if appropriate in an analogous manner.

In the context of the present invention, preferably more than one of the aspects designated as preferred above are implemented simultaneously; especially preferred are the combinations of such aspects and the corresponding features that are apparent from the appended claims.

### BRIEF DESCRIPTION OF THE DRAWINGS

The invention is described in detail hereinafter by an example and figures:

FIG. 1 describes, in schematic form, the layer structure of an inventive inkjet recording material;

FIG. 2 describes, in schematic form, the layer structure of an inventive inkjet recording material; and

FIG. 3 describes, in schematic form, the layer structure of an inventive inkjet recording material.

### DETAILED DESCRIPTION OF THE PRESENTLY PREFERRED EMBODIMENTS

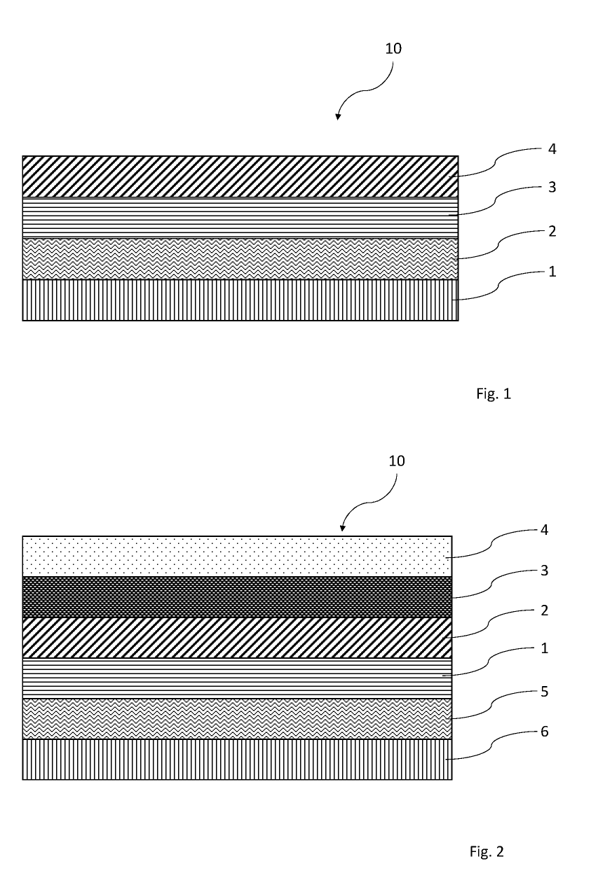

FIG. 1 describes, in schematic form, the layer structure of an inventive inkjet recording material (10) having a metallic look. A metal layer (3) has been applied by use of a polyurethane adhesive (2) to the front side of a sheetlike substrate (1), which in the present case is a coated paper. In the embodiment described here, the metal layer (3) is an aluminum layer. The aluminum layer in the present context has a thickness of about 20 nm. An ink-absorptive layer (4) is disposed atop said metal layer (3). The ink-absorptive layer comprises a polyvinyl alcohol as binder (degree of hydrolysis 95 mol %, degree of polymerization 800), boehmite as pigment and H₃BO₃.

FIG. 2 describes, in schematic form, the layer structure of an inventive inkjet recording material (10) as depicted in FIG. 1. However, the inventive inkjet recording material (10) depicted in FIG. 2 additionally comprises an adhesive layer (5) on the reverse side of the sheetlike substrate (1) and a release paper disposed atop the adhesive layer (5). The adhesive layer is a polyacrylic resin adhesive, and the release paper is a silicone-coated paper that has been rendered anti-adhesive with respect to the polyacrylic resin adhesive.

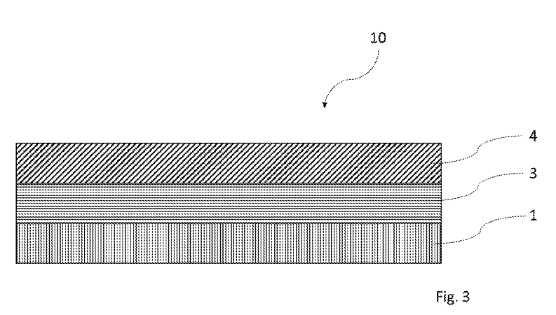

FIG. 3 describes, in schematic form, the layer structure of an inventive inkjet recording material (10) having a metallic look. A metal layer (3) has been applied with the aid of physical gas phase deposition to the front side of a sheetlike substrate (1), which in the present context is a coated paper. In the embodiment described here, the metal layer (3) is an aluminum layer. The aluminum layer in the present context has a coat weight of 0.9 g/m². An ink-absorptive layer (4) has been disposed atop said metal layer (3). The ink-absorptive layer comprises a polyvinyl alcohol as binder (degree of hydrolysis 95 mol %, degree of polymerization 800), boehmite as pigment and H₃BO₃.

### Example: Production of an Inventive Inkjet Recording Material Having a Metallic Look

In the first step, a 70 g/m² paper is coated with an aqueous polyurethane adhesive. Subsequently, the polyurethane adhesive-coated paper is laminated onto the aluminum layer of a single-sidedly aluminum-metallized (layer thickness 20 nm) BOPP film, with a release layer that enables the residue-free removal of the aluminum layer disposed between the aluminum layer and the BOPP (biaxially oriented polypropylene) film. The term separation layer can also find use as a synonym for release layer.

Subsequently, the polyurethane adhesive is dried and the BOPP film is removed along with the release layer.

The resulting three-layer composite consisting of paper, polyurethane adhesive layer and aluminum layer is coated with a coating composition with the aid of an intaglio printing method, and excess material is stripped off with a blade, so as to result in an application of 20 g/m² (dry).

The coating composition is the coating composition described in example 1 of DE 69402121 T2.

The coating composition applied is dried, so as to result in an ink-absorptive layer (4) or an inventive inkjet recording material having a metallic look.

The inkjet recording material produced is notable for very good printability by inkjet printing and has a pleasing metallic look.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An inkjet recording material having a metallic look, comprising:
a sheetlike substrate having a front side and a reverse side opposite the front side;
a metal layer; and
an ink-absorptive layer applied atop the metal layer that comprises:
a binder; and
pigments that have a pore diameter of below 1 μm measured with an aid of gas adsorption according to DIN 66135,
wherein the metal layer is arranged between the sheetlike substrate and the ink-absorptive layer.

17. The inkjet recording material according to claim 16, wherein the ink-absorptive layer comprises boric acid or a borate.

18. The inkjet recording material according to claim 16, wherein the ink-absorptive layer comprises a binder selected from the group consisting of polyvinyl alcohol, copolymer of polyvinyl alcohol, ethylene-vinyl acetate copolymer, starch, styrene-butadiene latex, and styrene-acrylate latex.

19. The inkjet recording material according to claim 16, wherein the binder in the ink-absorptive layer is polyvinyl alcohol.

20. The inkjet recording material according to claim 19, wherein the polyvinyl alcohol has a degree of hydrolysis of at least one of:
more than 50 mol %,
more than 75 mol %, and
more than 90 mol %.

21. The inkjet recording material according to claim 19, wherein the polyvinyl alcohol has a degree of polymerization of at least one of:
at least 500,
at least 800, and
at least 1000.

22. The inkjet recording material according to claim 19, wherein the ink-absorptive layer has a proportion by mass of 0.001 to 0.1 boric acid or borate, based on the polyvinyl alcohol used as binder.

23. The inkjet recording material according to claim 16, further comprising:
an adhesive configured as a polyurethane adhesive is disposed between the sheetlike substrate and the metal layer.

24. The inkjet recording material according to claim 16, wherein the ink-absorptive layer has a dry weight of at least one of:
a first range from 10 to 35 g/m²,
a second range from 12 to 25 g/m², and
a third range from 15 to 25 g/m².

25. The inkjet recording material according to claim 16, wherein the ink-absorptive layer is at least one of:
transparent,
has a first opacity according to ISO 2471 of not more than 80%,
has a second opacity according to ISO 2471 of not more than 50%, and
has a third opacity according to ISO 2471 of not more than 30%.

26. The inkjet recording material according to claim 16, wherein the sheetlike substrate has an adhesive layer on the reverse side.

27. The inkjet recording material according to claim 16, wherein the metal layer is an aluminum layer, copper layer, gold layer, or metal layer.

28. The inkjet recording material claim 23,
wherein the sheetlike substrate is a coated or uncoated paper,
wherein the adhesive is a polyurethane adhesive,
wherein the metal layer is an aluminum layer having a thickness of 15 μm to 30 μm,
wherein the ink-absorptive layer has a dry weight in a range from 10 to 35 g/m²,
wherein the binder in the ink-absorptive layer is polyvinyl alcohol,
wherein the polyvinyl alcohol has a degree of hydrolysis of more than 50 mol % and a degree of polymerization of at least 500,
wherein the ink-absorptive layer has a proportion by mass of 0.001 to 0.1 boric acid or borate, based on the polyvinyl alcohol used as binder, and
wherein the ink-absorptive layer is one of transparent or has an opacity according to ISO 2471 of not more than 80%.

29. The inkjet recording material claim 23, configured as at least one of labels, photos, posters, books, photo books, displays, playing cards or collecting cards, entry tickets, ID cards, tags, or packaging materials.

30. The inkjet recording material claim 16, pigments that have a pore diameter of greater than 0.3 μm

31. A process for producing an inkjet recording material, comprising one of:
A)
providing a sheetlike substrate, having a front side and a reverse side opposite the front side;
providing a multilayer composite composed of a metal layer, a release layer, and a carrier layer;
coating the front side of the sheetlike substrate and/or the metal layer of the multilayer composite with an adhesive;
laminating the multilayer composite that has been coated with the adhesive onto the sheetlike substrate such that the adhesive is disposed between the front side of the sheetlike substrate and the metal layer;
one of partly or fully drying or curing the adhesive, to result in an adhesive layer;
removing the carrier layer and the release layer,
corona-treating the metal layer;
providing a coating composition for production of an ink-absorptive layer;
applying the coating composition to the metal layer, and
drying the applied coating composition to form an ink-absorptive layer;
or
B)
providing the sheetlike substrate having the front side and the reverse side opposite the front side;
coating the front side of the sheetlike substrate with the metal layer by physical gas phase deposition;
providing the coating composition for production of the ink-absorptive layer;
applying the coating composition to the metal layer; and
drying the applied coating composition to form the ink-absorptive layer.
